(19) United States
(12) Patent Application Publication
(10) Pub. No.: US 2018/0090097 A1
(43) Pub. Date: Mar. 29, 2018

(54) SIGNAL GENERATING CIRCUIT AND SIGNAL GENERATING METHOD

(71) Applicant: AU OPTRONICS CORPORATION, Hsin-chu (TW)

(72) Inventors: Che-Wei TUNG, Hsin-chu (TW); Wei-Li LIN, Hsin-chu (TW)

(21) Appl. No.: 15/482,393

(22) Filed: Apr. 7, 2017

(30) Foreign Application Priority Data
Sep. 23, 2016 (TW) 105130827

(51) Int. Cl. G09G 5/00

(52) U.S. Cl. CPC G09G 5/003; G09G 2330/021; G09G 2310/0289; G09G 2310/08

(57) ABSTRACT

A signal generating circuit that includes a timing controller and a level shifter is provided. The level shifter is electrically connected to the timing controller. The timing controller generates a clock signal and a control signal. The level shifter receives the clock signal and the control signal. The level shifter outputs a high level signal during a positive half period of a period according to the clock signal and the control signal and partially increases the high level signal, and then the level shifter outputs a low level signal during a negative half period of the period according to the clock signal and the control signal and partially decreases the low level signal.

### CROSS-REFERENCE TO RELATED PATENT APPLICATION

This application claims the benefit of priority to Taiwan Patent Application No. 105130827, filed Sep. 23, 2016. The entire content of the above identified application is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present invention relates to a signal processing circuit and a signal processing method, and in particular, to a signal generating circuit and a signal generating method.

### BACKGROUND

With the rapid development of image display technologies, the image display technologies are widely applied to display apparatuses. For example, a display apparatus formed by a Gate Driver On Array (GOA) circuit is characterized by being highly integrated and thin. However, a shift register in the GOA circuit is configured to receive and copy, at a preset timing, a level signal provided by a signal generating circuit, so as to generate an output signal. Therefore, a wave of the output signal generated by the GOA circuit not only depends on electric properties of a Thin-Film Transistor (TFT) of the GOA circuit, but also closely relates to a voltage value corresponding to a wave of the level signal. Generally, the output signal generated by the GOA circuit is generated by copying the wave of the level signal, and therefore, as compared with the level signal, performances (for example, signal delay) of the wave of the output signal are significantly attenuated.

Therefore, how to design a signal generating circuit by effectively maintaining operation of a GOA circuit and improve performances of a wave of an output signal is a big challenge.

### SUMMARY

An aspect of the present disclosure relates to a signal generating circuit. The signal generating circuit includes a timing controller and a level shifter, and the level shifter is electrically connected to the timing controller. The timing controller is configured to generate a clock signal and a control signal. The level shifter is configured to receive the clock signal and the control signal. In addition, the level shifter outputs a high level signal during a positive half period of a period according to the clock signal and the control signal and partially increases the high level signal, and then outputs a low level signal during a negative half period of the period according to the clock signal and the control signal and partially decreases the low level signal.

Another aspect of the present disclosure relates to a signal generating method, and the sensing method includes the following steps: generating a clock signal and a control signal by a timing controller; receiving the clock signal and the control signal by a level shifter; outputting, by the level shifter, a high level signal during a positive half period of a period according to the clock signal and the control signal and partially increasing the high level signal; and outputting, by the level shifter, a low level signal during a negative half period of the period according to the clock signal and the control signal and partially decreasing the low level signal.

To sum up, the technical solutions of the present disclosure has obvious advantages and beneficial effects as compared with the related art. The foregoing technical solutions can achieve substantial technical progress and can be widely used in industrial applications. In the signal generating circuit and the signal generating method of the present disclosure, level signals are partially adjusted, so that a shift register in a GOA circuit can output an output signal with more ideal wave performances according to the adjusted level signals. For example, in the signal generating circuit and the signal generating method of the present disclosure, a high level signal and a low level signal are outputted, the high level signal is partially increased, and the low level signal is partially decreased. In addition, as compared with conventional technical solutions for increasing or decreasing a whole level signal, in the signal generating circuit and the signal generating method of the present disclosure, the level signals are merely partially adjusted. Therefore, the technical solution of the present disclosure can significantly reduce power consumption.

### BRIEF DESCRIPTION OF THE DRAWINGS

The disclosure will become more fully understood from the detailed description given herein below for illustration only, and thus are not limitative of the disclosure, and wherein:

FIG. 1A is a schematic block diagram of a signal generating circuit according to an embodiment of the present disclosure;

FIG. 1B is a schematic block diagram of a shift register according to the embodiment of the present disclosure;

FIG. 1C is a circuit schematic diagram of the shift register according to the embodiment of the present disclosure;

FIG. 2A, FIG. 2B, and FIG. 2C are schematic diagrams of waves of level signals generated by a signal generating circuit according to an embodiment of the present disclosure; and

FIG. 3 is a flowchart of a signal generating method according to an embodiment of the present disclosure.

### DETAILED DESCRIPTION

The following describes the embodiments with reference to the accompanying drawings in detail, so as to make the aspects of the present disclosure more comprehensible. However, the provided embodiments are not intended to limit the scope of the present disclosure, and the description of the operation of a structure is not intended to limit an execution sequence. Any apparatus with equivalent functions that is produced from a structure formed by a recombination of elements shall fall within the scope of the present disclosure. Besides, according to industry standards and practices, the drawings are merely intended to assist the description, and are not drawn according to original dimensions. In practice, dimensions of various features may be arbitrarily increased or decreased to facilitate the description. Same elements in the description below are indicated by a same reference sign, so as to facilitate the comprehension.

The terms used in this specification and the claims generally have their ordinary meanings in the art, within the context of the disclosure, and in the specific context where each term is used, unless otherwise specifically denoted. Certain terms that are used to describe the present disclosure are discussed below, or elsewhere in the specification, to provide additional guidance to a person skilled in the art regarding the description of the present disclosure.

Besides, as used herein, the terms “including”, “comprising”, “having”, “containing”, and the like are to be understood to be open-ended, i.e., to mean including but not limited to.

In the present disclosure, when an element is “connected” or “coupled”, it may indicate that the element is “electrically connected” or “electrically coupled”. “Connected” or “coupled” may further be used to indicate that two or more elements operate cooperatively or interact with each other. Besides, although terms such as “first” and “second” are used in the present disclosure to describe different elements, the terms are merely used to distinguish between elements or operations that are described by a same technical term. Unless clearly indicated in the context otherwise, the terms are not intended to indicate specific denotations or imply a sequence or an order, and are not intended to limit the present disclosure.

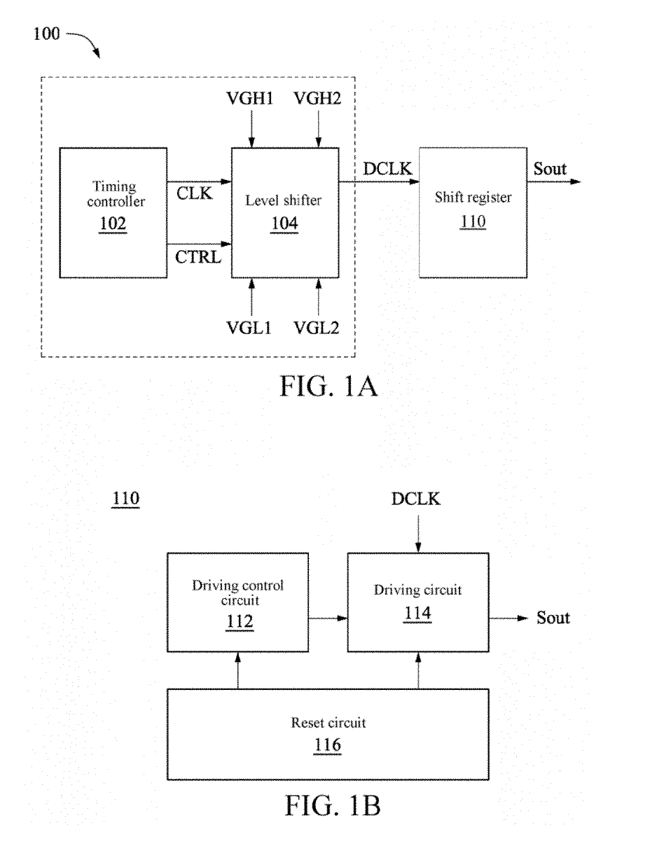

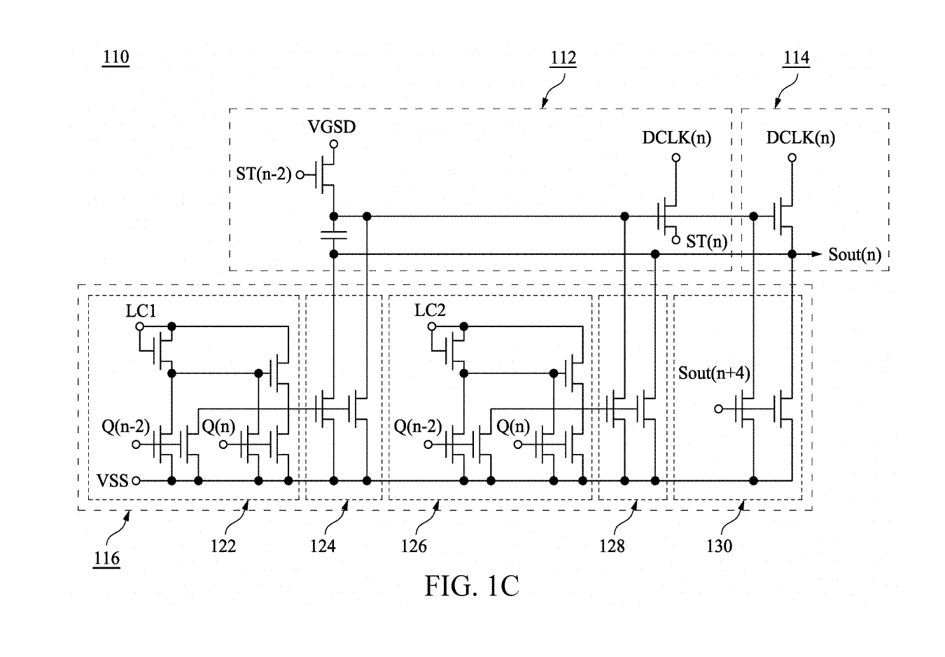

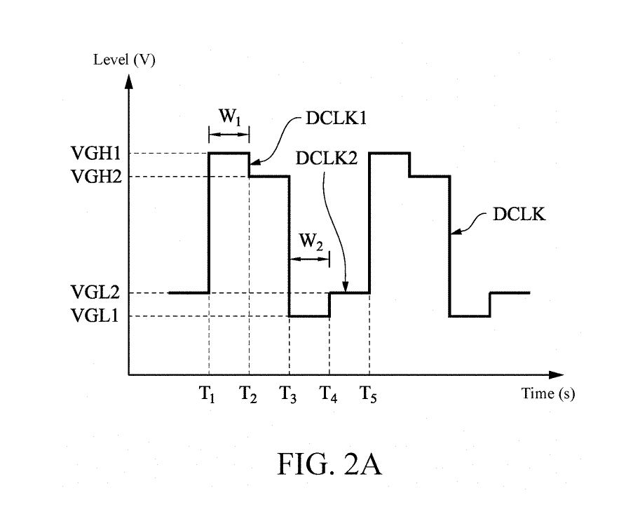

FIG. 1A is a schematic block diagram of a signal generating circuit 100 according to an embodiment of the present disclosure. As shown in FIG. 1A, the signal generating circuit 100 includes a timing controller 102 and a level shifter 104, and the level shifter 104 is electrically connected to the timing controller 102. The timing controller 102 is configured to generate a clock signal CLK and a control signal CTRL, and transmit the clock signal CLK and the control signal CTRL to the level shifter 104. The level shifter 104 is configured to receive the clock signal CLK and the control signal CTRL, and output a level signal DCLK according to the clock signal CLK and the control signal CTRL. In this embodiment, the level shifter 104 is further configured to receive a first high level voltage VGH1, a second high level voltage VGH2, a first low level voltage VGL1, and a second low level voltage VGL2.

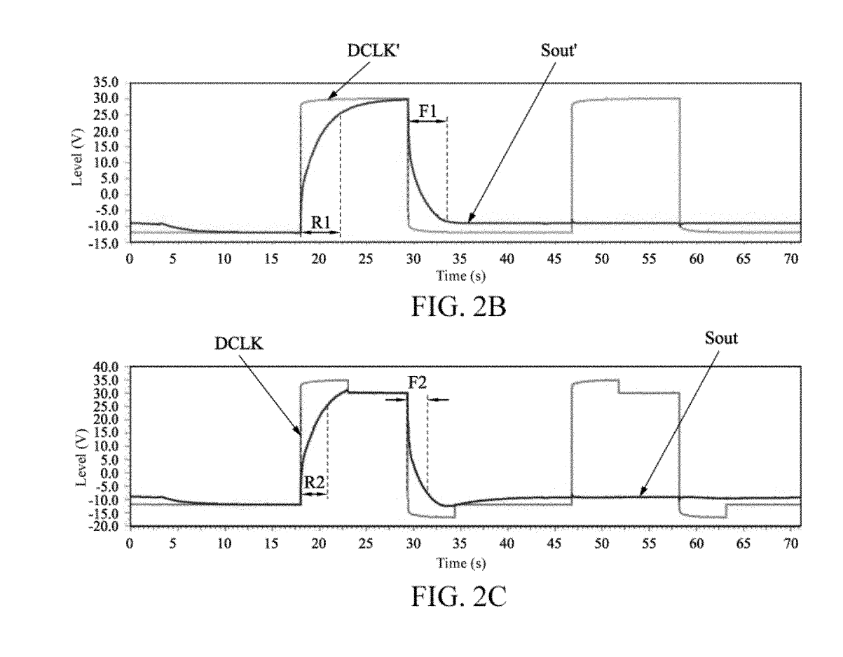

In one embodiment, the level shifter 104 first outputs a high level signal (for example, the high level signal DCLK1 shown in FIG. 2A) during a positive half period of a period according to the clock signal CLK and the control signal CTRL, and partially increases the high level signal. Subsequently, the level shifter 104 further outputs a low level signal (for example, the low level signal DCLK2 shown in FIG. 2A) during a negative half period of the period according to the clock signal CLK and the control signal CTRL, and partially decreases the low level signal. In this way, the level shifter 104 can output the level signal DCLK according to the increased high level signal and the decreased low level signal. For example, referring to FIG. 2A, FIG. 2A is a schematic diagram of a wave of a level signal DCLK generated by the signal generating circuit 100 according to an embodiment of the present disclosure. As shown in FIG. 2A, after the level shifter 104 outputs the high level signal DCLK1 during the positive half period (for example, the time from T1 to T3) of the period (for example, the time from T1 to T5), the level shifter 104 partially (for example, the partial time from T1 to T2 in the period of T1 to T5) increases the high level signal DCLK1; and after the level shifter 104 outputs the low level signal DCLK2 during the negative half period (for example, the time from T3 to T5) of the period (for example, the time from T1 to T5), the level shifter 104 partially (for example, the partial time from T3 to T4 in the period of T1 to T5) decreases the low level signal DCLK2.

In another embodiment, the level shifter 104 first outputs a first high level signal during a first period of the positive half period according to the clock signal CLK and the control signal CTRL, and outputs a second high level signal during a second period of the positive half period, a level of the first high level signal being greater than a level of the second high level signal. Subsequently, the level shifter outputs a first low level signal during a third period of the negative half period according to the clock signal CLK and the control signal CTRL, and outputs a second low level signal during a fourth period of the negative half period, a level of the first low level signal being less than a level of the second low level signal. For example, referring to FIG. 2A, when the level shifter 104 outputs the high level signal DCLK1 during the positive half period (for example, the time from T1 to T3) of the period (for example, the time from T1 to T5), the level shifter 104 adjusts the high level signal DCLK1 to the first high level voltage VGH1 during a first period (for example, the time from T1 to T2) of the positive half period, so as to output the first high level signal, and the level shifter 104 adjusts the high level signal DCLK1 to the second high level voltage VGH2 during a second period (for example, the time from T2 to T3) of the positive half period, so as to output the second high level signal; and when the level shifter 104 outputs the low level signal DCLK2 during the negative half period (for example, the time from T3 to T5) of the period (for example, the time from T1 to T5), the level shifter 104 adjusts the low level signal DCLK2 to the first low level voltage VGL1 during a third period (for example, the time from T3 to T4) of the negative half period, so as to output the first low level signal, and the level shifter 104 adjusts the low level signal DCLK2 to the second low level voltage VGL2 during a fourth period (for example, the time from T4 to T5) of the negative half period, so as to output the second low level signal.

In still another embodiment, the level of the first high level signal is the first high level voltage VGH1, and the level of the second high level signal is the second high level voltage VGH2; and the level of the first low level signal is the first low level voltage VGL1, and the level of the second low level signal is the second low level voltage VGL2. In addition, the level of the first high level signal is greater than the level of the second high level signal, and the level of the first low level signal is less than the level of the second low level signal. In other words, the first high level voltage VGH1 is greater than the second high level voltage VGH2, and the first low level voltage VGL1 is less than the second low level voltage VGL2. In this embodiment, a difference between the first high level voltage VGH1 and the second high level voltage VGH2 is 5 V, and a difference between the first low level voltage VGL1 and the second low level voltage VGL2 is 5 V. It should be understood that the foregoing implementation manners related to the first high level voltage VGH1, the second high level voltage VGH2, the first low level voltage VGL1, and the second low level voltage VGL2 are merely used for illustration, and are not intended to limit the present disclosure. For example, according to requirements of actual operations, the levels of the first high level signal, the second high level signal, the first low level signal, and the second low level signal can be flexibly adjusted.

In one embodiment, the timing controller 102 is further configured to adjusts, via the level shifter 104, time lengths of the first period of the positive half period and the third period of the negative half period. For example, referring to FIG. 2A, after the timing controller 102 increases or decreases a time length W1 of the first period, the level shifter 104 outputs, according to the time length W1 of the first period obtained after the adjustment, the first high level signal having the time length W1 during the first period (for example, the time from T1 to T2) of the positive half period (for example, the time from T1 to T3); and after the timing controller 102 increases or decreases a time length W2 of the third period, the level shifter 104 outputs the first low level signal during the third period (for example, the time from T3 to T4) of the negative half period (for example, the time from T3 to T5) according to the time length W2 of the third period obtained after the adjustment. In this embodiment, the time length W1 of the first period and the time length W2 of the third period are both 5 microseconds, but the implementation manners of the present disclosure are not limited thereto.

In one embodiment, the level shifter 104 is further configured to transmit the output level signal DCLK to the shift register 110, so that the shift register 110 generates an output signal Sout according to the level signal DCLK. For example, referring to FIG. 1B and FIG. 1C, FIG. 1B is a schematic block diagram of the shift register 110 according to the embodiment of the present disclosure, and FIG. 1C is a circuit schematic diagram of the shift register 110 according to the embodiment of the present disclosure. As shown in FIG. 1B, the shift register 110 includes a driving control circuit 112, a driving circuit 114, and a reset circuit 116, the driving control circuit 112 is electrically connected to the driving circuit 114, and the reset circuit 116 is electrically connected to the driving control circuit 112 and the driving circuit 114. The driving control circuit 112 is configured to generate and transmit a driving control signal to the driving circuit 114. The driving circuit 114 is configured to copy, according to the driving control signal at a preset timing, the level signal DCLK outputted by the signal generating circuit 100, so as to generate the output signal Sout. The reset circuit 116 is configured to generate a reset signal and transmit the reset signal to the driving control circuit 112 and the driving circuit 114, so as to reset the driving control circuit 112 and the driving circuit 114, thereby generating the output signal Sout again.

As shown in FIG. 1C, the driving control circuit 112 is electrically connected to a power source VGSD, and the driving control circuit 112 is configured to generate the driving control signal according to an earlier-level scan signal ST(n−2), and generates a current-level scan signal ST(n) according to the driving control signal and a current-level level signal DCLK(n). The driving circuit 114 is configured to generate a current-level output signal Sout(n) according to the driving control signal and the current-level level signal DCLK(n). The reset circuit 116 includes a first regulator control circuit 122, a first regulator circuit 124, a second regulator control circuit 126, a second regulator circuit 128, and a pull-down circuit 130, which are all electrically connected to the power source VSS. The first regulator control circuit 122 is configured to generate a first regulator control signal according to a first low-frequency drive signal LC1, an earlier-level control signal Q(n−2), and a current-level control signal Q(n), and transmits the first regulator control signal to the first regulator circuit 124, so as to regulate voltages of the driving control circuit 112 and the driving circuit 114. The second regulator control circuit 126 is configured to generate a second regulator control signal according to a second low-frequency drive signal LC2, the earlier-level control signal Q(n−2), and the current-level control signal Q(n), and transmits the second regulator control signal to the second regulator circuit 128, so as to regulate the voltages of the driving control circuit 112 and the driving circuit 114. The pull-down circuit 130 is configured to pull down the voltage of the driving circuit 114 according to a later-level output signal Sout(n+4).

In one embodiment, referring to FIG. 2B and FIG. 2C, if the level shifter 104 transmits a level signal DCLK′ that is not partially adjusted to the shift register 110, a wave of an output signal Sout′ is significantly attenuated; and if the level shifter 104 transmits a level signal DCLK that is partially adjusted to the shift register 110, attenuation of a wave of the output signal Sout can be effectively reduced. In this embodiment, a rise time R1 corresponding to the output signal Sout′ is 4.41 microseconds, and a fall time F1 corresponding to the output signal Sout′ is 2.92 microseconds. In addition, when a level difference between the first high level signal and the second high level signal is 5 V, a level difference between the first low level signal and the second low level signal is 5 V, and the time length W1 of the first period corresponding to the first high level signal and the time length W3 of the third period corresponding to the first low level signal are both 5 microseconds, a rise time R2 corresponding to the output signal Sout is 3.49 microseconds, and a fall time F2 corresponding to the output signal Sout is 2.07 microseconds. Therefore, as compared with the output signal Sout′, the output signal Sout has a more ideal rise time and fall time, and therefore, the wave of the output signal Sout is closer to an ideal square wave.

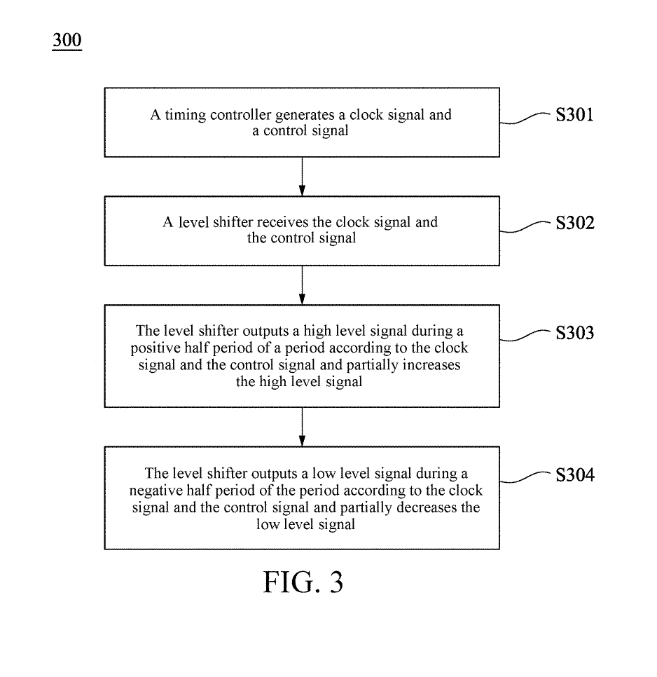

FIG. 3 is a flowchart of a signal generating method 300 according to an embodiment of the present disclosure. In one embodiment, the signal generating method 300 may be implemented in the foregoing signal generating circuit 100, but the present disclosure is not limited thereto. To facilitate the comprehension of the signal generating method 300, the following uses the signal generating circuit 100 as an exemplary subject in which the signal generating method 300 is implemented. As shown in FIG. 3, the signal generating method 300 includes the following steps:

S301: The timing controller 102 generates the clock signal CLK and the control signal CTRL.

S302: The level shifter 104 receives the clock signal CLK and the control signal CTRL.

S303: The level shifter 104 outputs a high level signal during a positive half period of a period according to the clock signal CLK and the control signal CTRL and partially increases the high level signal.

S304: The level shifter 104 outputs a low level signal during a negative half period of the period according to the clock signal CLK and the control signal CTRL and partially decreases the low level signal.

For example, after the level shifter 104 outputs the high level signal (for example, the high level signal DCLK1 shown in FIG. 2A) and the low level signal (for example, the low level signal DCLK2 shown in FIG. 2A), and partially increases the high level signal and decreases the low level signal, the level shifter 104 can output the level signal DCLK according to the increased high level signal and the decreased low level signal.

In one embodiment, referring to step s303, the level shifter 104 outputs the first high level signal during the first period of the positive half period according to the clock signal CLK and the control signal CTRL, and outputs the second high level signal during the second period of the positive half period. The implementation manners of the first high level signal and the second high level signal are shown in the foregoing embodiment (referring to FIG. 2A), and therefore, the details are not described herein again. In another embodiment, the level of the first high level signal is the first high level voltage VGH1, the level of the second high level signal is the second high level voltage VGH2, and the level of the first high level signal is greater than the level of the second high level signal.

In one embodiment, referring to step s303 again, the level shifter 104 outputs the first low level signal during the third period of the negative half period according to the clock signal CLK and the control signal CTRL, and outputs the second low level signal during the fourth period of the negative half period. The implementation manners of the first low level signal and the second low level signal are shown in the foregoing embodiment (referring to FIG. 2A), and therefore, the details are not described herein again. In still another embodiment, the level of the first low level signal is the first low level voltage VGL1, the level of the second low level signal is the second low level voltage VGL2, and the level of the first low level signal is less than the level of the second low level signal.

In the foregoing embodiment, in the signal generating circuit and the signal generating method of the present disclosure, level signals are partially adjusted, so that a shift register in a GOA circuit can output an output signal with better wave performances according to the adjusted level signals. For example, in the signal generating circuit and the signal generating method of the present disclosure, a high level signal and a low level signal are outputted, the high level signal is partially increased, and the low level signal is partially decreased. In addition, as compared with conventional technical solutions for increasing or decreasing a whole level signal, in the signal generating circuit and the signal generating method of the present disclosure, the level signals are merely partially adjusted. Therefore, the technical solution of the present disclosure can substantially reduce power consumption.

A person of ordinary skill in the art can easily understand the advantages of implementing, by the disclosed embodiments, one or more of the foregoing examples. After reading the foregoing specification, a person of ordinary skill in the art is capable of making various modifications, replacements, equivalents, and multiples other embodiments on the basis of the disclosure herein. Therefore, the protection scope of the present disclosure mainly includes the protection scope defined in the claims and an equivalent scope thereof.

What is claimed is:

1. A signal generating circuit, comprising:
a timing controller, configured to generate a clock signal and a control signal; and
a level shifter, electrically connected to the timing controller, and configured to receive the clock signal and the control signal, wherein the level shifter outputs a high level signal during a positive half period of a period according to the clock signal and the control signal and partially increases the high level signal, and the level shifter outputs a low level signal during a negative half period of the period according to the clock signal and the control signal and partially decreases the low level signal.

2. The signal generating circuit according to claim 1, wherein the level shifter further outputs a first high level signal during a first period of the positive half period according to the clock signal and the control signal, and outputs a second high level signal during a second period of the positive half period, a level of the first high level signal being greater than a level of the second high level signal; and the level shifter further outputs a first low level signal during a third period of the negative half period according to the clock signal and the control signal, and outputs a second low level signal during a fourth period of the negative half period, a level of the first low level signal being less than a level of the second low level signal.

3. The signal generating circuit according to claim 2, wherein the level shifter is further configured to adjust time lengths of the first period and the third period.

4. The signal generating circuit according to claim 2, wherein the level shifter is further configured to adjust the levels of the first high level signal and the first low level signal.

5. The signal generating circuit according to claim 2, wherein the level shifter sequentially outputs the first high level signal, the second high level signal, the first low level signal and the second low level signal during, respectively, the first period, the second period, the third period, and the fourth period in order.

6. A signal generating method, comprising:
generating a clock signal and a control signal by a timing controller;
receiving the clock signal and the control signal by a level shifter;
outputting, by the level shifter, a high level signal during a positive half period of a period according to the clock signal and the control signal and partially increasing the high level signal; and
outputting, by the level shifter, a low level signal during a negative half period of the period according to the clock signal and the control signal and partially decreasing the low level signal.

7. The signal generating method according to claim 6, wherein the outputting, by the level shifter, a high level signal during a positive half period of a period according to the clock signal and the control signal and partially increasing the high level signal comprises:
outputting, by the level shifter, a first high level signal during a first period of the positive half period according to the clock signal and the control signal, and outputting a second high level signal during a second period of the positive half period, a level of the first high level signal being greater than a level of the second high level signal; and
the outputting, by the level shifter, a low level signal during a negative half period of the period according to the clock signal and the control signal and partially decreasing the low level signal comprises:
outputting a first low level signal during a third period of the negative half period according to the clock signal and the control signal, and outputting a second low level signal during a fourth period of the negative half period, a level of the first low level signal being less than a level of the second low level signal.

8. The signal generating method according to claim 7, comprising:
adjusting time lengths of the first period and the third period by the timing controller.

9. The signal generating method according to claim 7, comprising:
adjusting the levels of the first high level signal and the first low level signal by the level shifter.

10. The signal generating method according to claim 7, comprising:
sequentially outputting the first high level signal, the second high level signal, the first low level signal and the second low level signal by the level shifter during, respectively, the first period, the second period, the third period, and the fourth period.
